(19) United States
(12) Patent Application Publication
(10) Pub. No.: US 2006/0034503 A1
(43) Pub. Date: Feb. 16, 2006

(54) Medical image processing system

(75) Inventor: Toshihide Shimayama, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/194,480

(22) Filed: Aug. 2, 2005

(30) Foreign Application Priority Data
Aug. 12, 2004 (JP) 235292/2004

(51) Int. Cl. G06K 9/00

(52) U.S. Cl. 382/132

(57) ABSTRACT

A medical image processing system having an image generation unit; an image quality inspection terminal; and an image interpretation terminal is provided. The system is capable of determining whether additional imaging or the like is required and the type objectively and rapidly prior to an image interpretation to be performed by a doctor to further improve the efficiency of the image interpretation and diagnosis. An additional imaging determining section is incorporated into a QA-WS (image quality inspection terminal). The determining section is configured to perform a predetermined image analysis on the image data generated by the image generation unit to determine whether additional imaging or the like is required and the type objectively. The inspection engineer performs image quality inspection, and directs additional imaging or the like, if necessary, by referring to the determination result at the QA-WS.

### BACKGROUND OF THE INVENTION

1. Field of the Invention

The present invention relates to a medical image processing system. More specifically, the present invention is directed to a medical image processing system configured to generate digital medical images and inspect image qualities of the generated images to display qualified medical images for interpretation.

2. Description of the Related Art

In the medical field, medical image processing systems are used to facilitate medical image interpretation works. The system has a medical image generation unit for generating a digital medical image; an image quality inspection terminal having an output decision accepting function for automatically or manually accepting a decision whether to output the medical image generated by the image generation unit and inputted to the terminal; and an interpretation terminal for displaying the medical image inputted from the image quality inspection terminal.

The system is operated, for example, in the following manner. Initially, when a predetermined region of a patient is imaged by an imaging engineer using an imaging device that forms a part of the medical image generation unit, a digital medical image representing the region is generated in the medical image generation unit, and outputted to the image quality inspection terminal. In the image quality inspection terminal, the image inputted to the terminal is displayed on the display screen for image quality inspection and corrections, if required, such as the location of the region on the image (framing), focusing, contrast, and the like, by an inspection engineer. If the image is qualified as a medical image having an appropriate image quality for interpretation after or without corrections, the image is outputted to a database for storage. On the other hand, if the image quality is not improved to an adequate level even after image corrections have been performed, the medical image is not outputted, and the imaging engineer or the like is directed to regenerate the image. Thereafter, the medical image stored in the image database is called upon by a doctor to the interpretation terminal, and image processing or the like is further implemented, if necessary, before being displaying on the screen. In this way, the doctor may give a diagnosis to the patient by interpreting the image displayed on the display screen.

According to the medical image processing system, the image quality of the medical image generated by the medical image generation unit is inspected at the image quality inspection terminal before the image is served for interpretation. This may reduce the cases where additional image corrections or regeneration of the image is unavoidable at the time of image interpretation. Thus, the efficiency of the image interpretation and diagnosis may be improved.

In the medical image processing system described above, however, there still exist causes that degrade the efficiency of image interpretation and diagnosis, and the need for the means to eliminate these causes is still exist.

For example, when an image quality inspection is performed by an inspection engineer at the image quality inspection terminal, the inspection accuracy and the time required for inspecting the image quality are dependent on the ability of the inspection engineer. In addition, the inspection accuracy may be degraded due to exhaustion of the inspection engineer for long working hours or the like. Thus, these are the contributing factors that degrade the efficiency of the diagnostic image interpretation.

As one of the means for eliminating the problem, an imaging support unit as described in Japanese Unexamined Patent Publication No. 4(1992)-000435 proposed by the applicant of the present invention may be used. The unit automatically determines whether an imaged region is arranged on an adequate location of a medical image by analyzing the image data, and issues a caution if it is arranged on an inadequate location. Incorporating the support unit in the image quality inspection terminal may reduce the cases where medical images having inadequately arranged imaged region are outputted by the inspection engineer by mistake.

In the mean time, when a doctor is to give a diagnosis by interpreting a medical image, there may be cases where the doctor has difficulties giving the diagnosis only with the predetermined medical image provided for the diagnostic image interpretation, and requires a different type of medical image for interpretation or another medical examination.

For example, in diagnosing a human chest, it is customary that a plain chest radiation image obtained using plain radiation is provided for diagnosis. If a shadow that appears to be a nodule is found on the plain chest radiation image, it may be necessary to perform CT-scanning of the chest, and to interpret the tomogram of the chest obtained in order to further assess the spatial location of the shadow, inner structure, contour, and the like. In addition, in diagnosing a human breast, for example, it is customary that a mammogram (breast radiation image) obtained by imaging the breast pressed between pressing plates is provided for diagnosis. If the breast on the mammogram is classified as the “dense mammary glands”, it may be necessary to perform another medical examination of the breast through ultrasound echo imaging since the dense mammary glands may hinder detailed observation of the breast.

In these cases, the diagnosis is suspended for the time being and resumed after another medical image of the patient required for the diagnosis has been obtained or after the patient has received a different medical examination and obtained the examination result.

The suspension of the diagnosis due to such an additional medical image or medical examination, however, increases the burden on both the patient and doctor, for the patient has to revisit the medical center and the doctor has to perform diagnostic image interpretation again, as well as causing degraded diagnostic efficiency.

Consequently, in the medical image processing system described above, it is customary for the inspection engineer to check to see if there is any other medical image or medical examination that may be necessary in the subsequent diagnosing step by observing the medical image displayed on the image quality inspection terminal, as well as verifying the image quality. Then, if it is determined that another medical image or medical examination is required, arrangements are made to obtain the image or to have the medical examination completed in advance in order to avoid double work for the diagnosis. In this way, the burden on both the patient and doctor is alleviated, and at the same time, the efficiency of diagnostic image interpretation is improved.

The method in which a medical image is inspected by an inspection engineer at the image quality inspection terminal, and additionally required medical image generation (additional imaging) or another medical examination (additional examination) is performed in advance, however, still suffers from the same problem as that found in the former method described above. That is, the inspection accuracy and the time required for inspecting the image quality are dependent on the ability of the inspection engineer. In addition, the inspection accuracy may be degraded due to exhaustion of the inspection engineer for long working hours or the like. Thus, these are the contributing factors that degrade the efficiency of the diagnostic image interpretation.

### SUMMARY OF THE INVENTION

The present invention has been developed in view of the circumstances described above, and it is an object of the present invention to provide a medical image processing system capable of determining objectively and rapidly whether additional imaging or a medical examination is required, and further determining the type of the required additional imaging or medical examination if it is determined necessary prior to image interpretation to be performed by a doctor, thereby further improving the efficiency of the image interpretation and diagnosis.

In the mean time, Japanese Unexamined Patent Publication No. 2001-187044 discloses an image collecting system. The system detects the type of abnormal spot and the extent, and outputs information indicating that an additional medical examination is required together with necessary imaging conditions when the abnormal spot falls into a particular type and locates in the predetermined area. But the system is not designed to be incorporated into the image quality inspection terminal for performing the image quality inspection described above. Further, the system determines whether or not an additional medical examination is required based on the extent of the abnormality. Still further, judging from the description contained in Japanese Unexamined Patent Publication No. 2001-187044, the use of the system is limited to the same modality for re-imaging. Accordingly, the system is dissimilar to the present invention.

A medical image processing system of the present invention comprises:

an image generation unit for generating a medical image that represents a test subject;

an image quality inspection terminal having an output decision accepting section for accepting a decision whether to output the medical image generated by the image generation unit and inputted thereto; and

an interpretation terminal for displaying the medical image inputted thereto from the image quality inspection terminal,

wherein the image quality inspection terminal further comprises:

a determining section configured to perform a first determination process for determining whether additional imaging or an additional medical examination is required based on the medical image inputted thereto, and a second determination process for determining the type of the required additional imaging or medical examination, if the additional imaging or medical examination is determined necessary by the first determination process; and

an output section configured to output information which indicates that the additional imaging or medical examination is required and the type thereof, if the additional imaging or medical examination is determined necessary by the determining section.

In the medical image processing system of the present invention, the medical image may be a plain chest radiation image, and the determining section may comprise a nodule shadow detecting section for detecting a nodule shadow candidate on the plain radiation chest image, and configured to determine that additional imaging is necessary when the nodule shadow candidate is detected by the nodule shadow detecting section, and to further determine that the type of the additional imaging required is tomographic imaging of the chest.

Further, in the medical image processing system of the present invention, the medical image may be a breast radiation image, and the determining section may comprise a tumor shadow detecting section for detecting a tumor shadow candidate on the breast radiation image, and configured to determine that additional imaging is necessary when the tumor shadow candidate is detected by the tumor shadow detecting section, and to further determine that the type of the additional imaging required is magnified imaging of the breast.

Still further, in the medical image processing system of the present invention, the medical image may be a breast radiation image, and the determining section may comprise a mammary gland classifying section for classifying the breast on the breast radiation image into one of a plurality of categories classified according to the distribution of the mammary glands, and configured to determine that additional imaging is necessary when the breast is classified by the mammary gland classifying section into a particular category of the plurality of categories, indicating that the breast has relatively dense mammary glands, and to further determine that the type of the additional medical examination required is a medical examination through ultrasound imaging.

Further, in the medical image processing system of the present invention, the output section may be configured to tag information which indicates that the additional imaging or medical examination is required and the type thereof to a medical image inputted to the image quality inspection terminal when the additional imaging or medical examination is determined necessary by the determining section.

The decision to be accepted by the “accepting section” may be an automatic decision or a manual input.

A determination on the appropriateness of the location of the imaged region on a medical image made automatically by the imaging support unit as described in Japanese Unexamined Patent Publication No. 4(1992)-000435 may be an example of the automatic decision.

The referent of “additional imaging” as used herein means additional imaging required for obtaining an image to be interpreted for giving a diagnosis, which is an image of different type from the originally generated medical image, when it is difficult to give the diagnosis by interpreting only the original medical image. The referent of “additional medical examination” as used herein means an additional medical examination required for giving a diagnosis, when it is difficult to give the diagnosis by interpreting only the original medical image.

The referent of “image of different type” as used herein means an image obtained by a different modality or a different imaging method.

The referent of “medical image” as used herein means any digital image which is suitable for use to give a diagnosis, such as a radiation image, tomographic (CT) image, MRI image, or the like.

The referent of “tomographic imaging” as used herein means what is known as the imaging by CT scanning.

The referent of “magnified imaging” as used herein means imaging a partial region of a subject by magnifying it such that the resolution or sharpness of the image is enhanced.

According to the medical image processing system of the present invention, the image quality inspection terminal has a determining section configured to perform a first determination process for determining whether additional imaging or an additional medical examination is required based on the medical image inputted thereto, and a second determination process for determining the type of the required additional imaging or medical examination, if the additional imaging or medical examination is determined necessary by the first determination; and the output section configured to output information which indicates that the additional imaging or medical examination is required and the type thereof, if the additional imaging or medical examination is determined necessary by the determining section. This allows the inspection engineer to direct additional imaging or an additional medical examination to be performed in advance by referring to the output from the output section. Consequently, it is possible to determine objectively and rapidly whether additional imaging or an additional medical examination is required, and to further determine the type of the additional imaging or medical examination, if the additional imaging or medical examination is determined necessary prior to the image interpretation to be performed by a doctor, thereby the efficiency of the image interpretation and diagnosis may be further improved.

Further, the determination whether additional imaging or an additional medical examination is required may be made through an existing image quality inspection terminal of a medical image processing system simultaneously with the image quality inspection by the inspection engineer for the medical image obtained through imaging, so that a separate determination terminal and additional personnel to be allocated to the separate terminal are not required. Thus, additional costs and space for the separate terminal are not required.

### BRIEF DESCRIPTION OF THE DRAWINGS

FIG. 1 is a block diagram of a medical image processing system 100 illustrating the configuration thereof.

FIG. 2 is a block diagram of an additional imaging determining section illustrating the configuration thereof.

FIG. 3 is a flow diagram illustrating the process flow of a QA-WS 20.

FIG. 4 is a drawing illustrating an example layout of the display screen of the QA-WS 20 when the image represented by the input image data is a chest X-ray image.

FIG. 5 is a drawing illustrating an example layout of the display screen of the QA-WS 20 when the image represented by the input image data is a breast X-ray image (Example 1).

FIG. 6 is a drawing illustrating an example layout of the display screen of the QA-WS 20 when the image represented by the input image data is a breast X-ray image (Example 2).

### DESCRIPTION OF THE PREFERRED EMBODIMENTS

Hereinafter, embodiments of the present invention will be described with reference to the accompanying drawings.

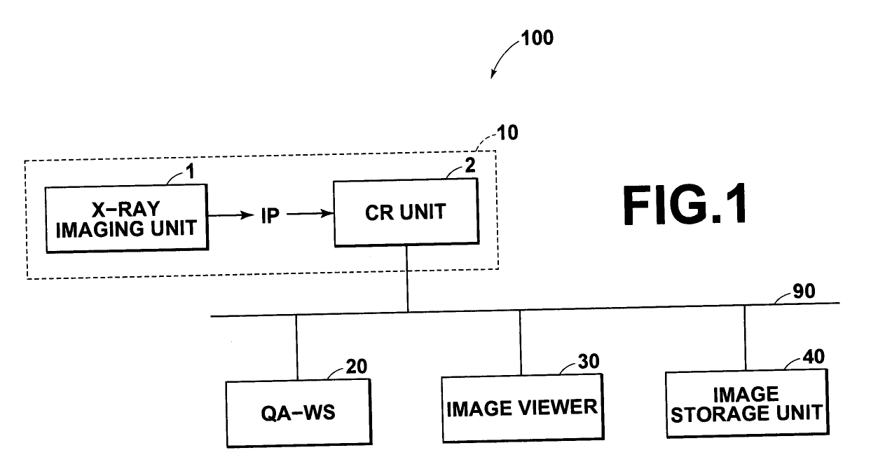

FIG. 1 is a block diagram of the medical image processing system 100 according to an embodiment of the present invention illustrating the overview thereof.

The medical image processing system 100 shown in FIG. 1 comprises: an X-ray image generation unit 10 (image generation unit) having an X-ray imaging unit 1 and a CR unit 2; a QA-WS 20 (image quality inspection terminal) for accepting a decision whether to output each of the medical images outputted from the X-ray image generation unit 10 and inputted thereto; an image viewer 30 (interpretation terminal) for displaying each of the medical images outputted from the QA-WS and inputted thereto; and an image storage unit 40 for storing various images, which are all connected to a network 90.

The X-ray imaging unit 1 emits X-rays to a test subject and receives X-rays transmitted through the test subject with a storage phosphor sheet IP having a sheet-like storage phosphor layer to record X-ray image information of the test subject on the storage phosphor sheet IP.

The CR unit 2 scans the storage phosphor sheet IP having X-ray image information recoded thereon by the X-ray imaging unit 1 with an exciting light beam, such as a laser beam or the like, to generate optically stimulated luminescence, then photoelectrically reads out the luminescence to obtain analog image signals, and converts them to digital signals to generate the image data.

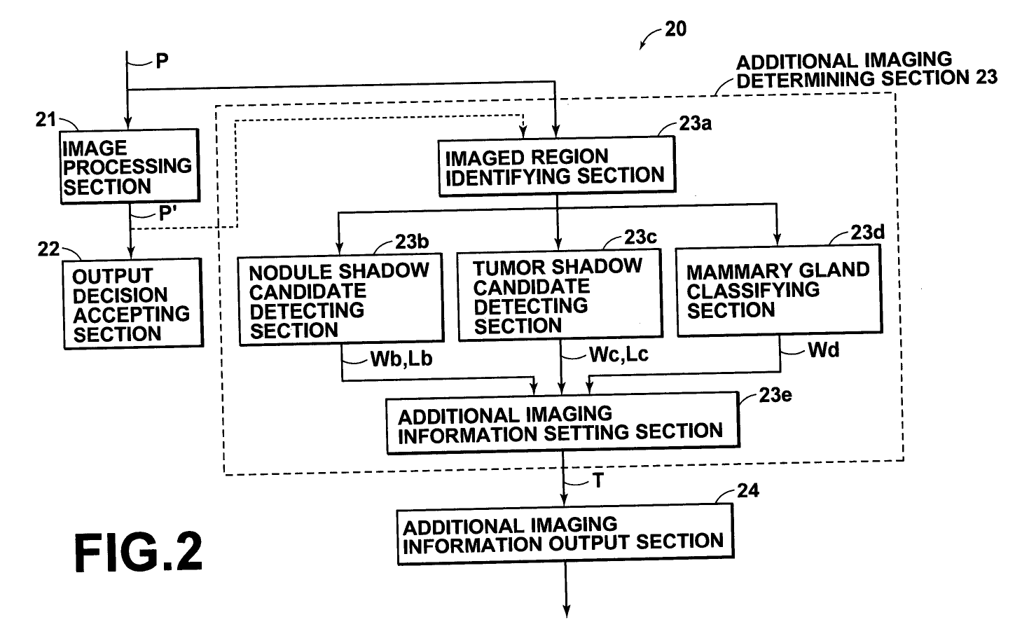

FIG. 2 is a block diagram of the QA-WS 20 illustrating the configuration thereof. The QA-WS 20 is a workstation comprising: an image processing section 21 for performing image processing, including a normalization process (EDR process) for image data P transmitted from the CR unit 2, image quality correction process, and the like; and an output decision accepting section 22 (decision accepting section) for accepting a decision whether to output processed image data P′ as a qualified image having an appropriate image quality for interpretation. The QA-WS 20 further comprises: an additional imaging determining section 23 (determining section) configured to perform a predetermined image analyzing process on the inputted image data P (or processed image data P′) to determine whether additional imaging or an additional medical examination is required based on the analysis result, and to further determine the type of the additional imaging or the like, if the additional imaging or the like is determined necessary by the determination based on the analysis result; and additional imaging information output section 24 (output section) for outputting additional imaging information T which indicates that the additional imaging or the like is required and the type thereof, if the additional imaging or the like is determined necessary by the additional imaging determining section 23.

As shown in FIG. 2, the additional imaging determining section 23 comprises: an imaged region identifying section 23a configured to identify the type of imaged region represented by the image data P based on the region information V tagged to the image data P; a nodule shadow candidate detecting section 23b configured to receive the image data P when the imaged region is identified as a chest region, to detect a nodule shadow candidate Qb on the chest X-ray image P (plain chest radiation image) represented by the image data P inputted therein (hereinafter, image data and the image represented thereby are indicated by the same reference symbol for convenience), and to output a detection result Wb, including location information Lb of the nodule shadow candidate Qb if detected; a tumor shadow candidate detecting section 23c configured to receive the image data P when the imaged region is identified as a breast region, to detect a tumor shadow candidate Qc on the breast X-ray image P (also referred to as breast radiation image or mammogram) represented by the image data P inputted therein, and to output a detection result Wc, including location information Lc of the tumor shadow candidate Qc if detected; and a mammary gland classifying section 23d configured to receive the image data P when the imaged region is identified as a breast region, to classify the breast of the breast X-ray image P represented by the image data P inputted therein into one of a plurality of categories classified according to the distribution of mammary glands, and to output a classification result Wd. The additional imaging determining section 23 further comprises an additional imaging information setting section 23e configured to determine whether a nodule shadow candidate has been detected based on the detection result Wb received from the nodule shadow candidate detecting section 23b, and to set the location information Lb and information indicating that “tomographic imaging of the chest region is required” as the additional imaging information T, if it determines that the nodule shadow has been detected. The additional imaging information setting section 23e also configured to determine whether a tumor shadow candidate has been detected based on the detection result Wc received from the tumor shadow candidate detecting section 23c, and to set the location information Lc and information indicating that “magnified imaging of the tumor shadow candidate region of the breast is required” as the additional imaging information T, if it determines that the tumor shadow candidate has been detected. The section 23e further configured to determine whether the breast has been classified into a particular category which indicates that the breast has relatively dense mammary glands based on the classification result Wd received from the mammary gland classifying section 23d, and to set the particular category information and information indicating that “a medical examination of the breast through ultrasound imaging is required”, if it determines that the breast has been classified into the particular category.

The QA-WS 20 comprises: a memory for storing image data; input devices for accepting input from the operator, including a keyboard, mouse, and the like; and a display for displaying images and the like.

The image viewer 30 is a computer configured to display the image represented by the image data outputted from the QA-WS 20 on the display. A doctor is supposed to interpret the image displayed on the display screen for giving a diagnosis.

The image storage unit 40 is a computer configured to store/manage image and other data, having a large memory for storing them.

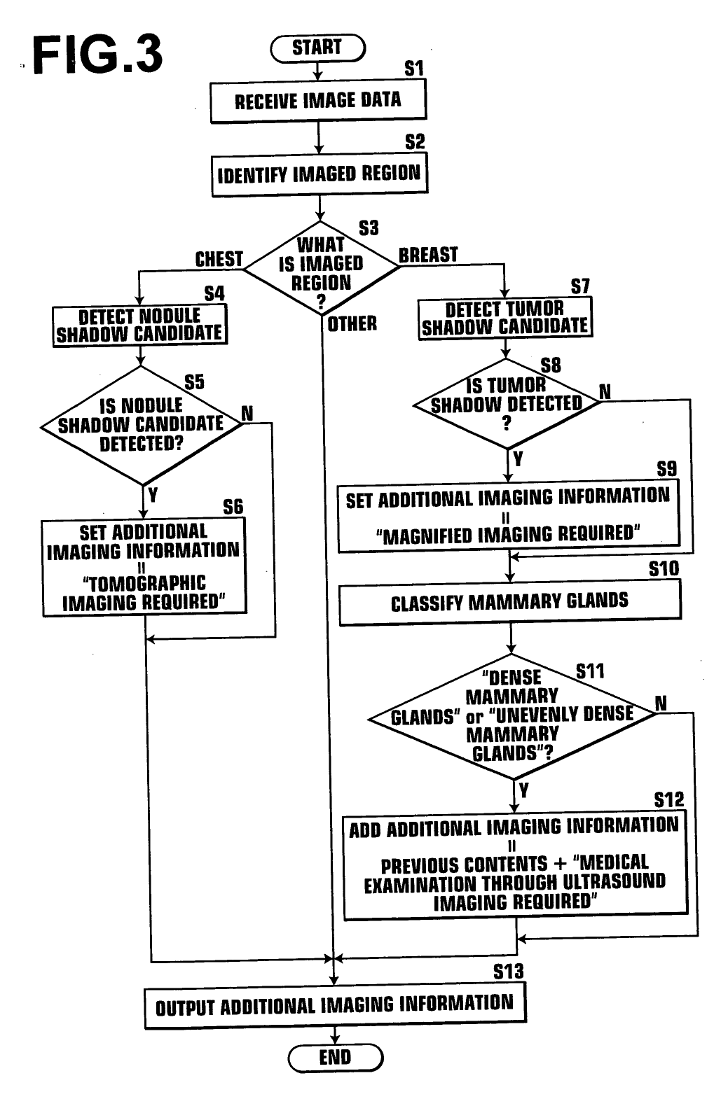

Hereinafter, the process flow of the medical image processing system 100 will be described. FIG. 3 is a flow diagram schematically illustrating a process flow of the QA-WS 20.

Initially, a predetermined region of a patient is X-rayed at the X-ray imaging unit 1, and image data P representing the X-ray image of the predetermined region is generated at the CR Unit 2. In generating the image data P at the CR unit 2, patient information Q that includes a patient ID for identifying each patient and region information V that indicates the imaged region of the patient are tagged to the image data P to indicate which region of which patient is represented by the image data P.

Thereafter, the QA-WS 20 receives the image data P generated by the CR unit 2, and stores them in its own memory, which is not shown (step S1). The imaged region identifying section 23a obtains the region information V tagged to the image data P from the memory, and identifies the imaged region of the image data P based on the region information V (step S2). Then, the section 23a checks the identified imaged region to see if it is “a chest region”, “abreast”, or “other”. Hereinafter, the subsequent process flow will be described separately for each case where the imaged region is “a chest region”, “a breast” or “other”.

When the imaged region is “a chest region”, the nodule shadow candidate detecting section 23b performs a process for detecting a nodule shadow candidate Qb on the chest X-ray image P represented by the image data P inputted therein (step S4). For example, the detection method may comprise the steps of: performing a digitizing process on an emphasized medical image using different thresholds to obtain a plurality of digitized images as described in Japanese Patent Application No. 2004-009398; detecting an abnormal (nodule) shadow candidate based on the shape and size of the region, and statistic amounts of pixel values within the region appeared on each digitized images; and determining whether the region is pseudopositive or not based on the characteristic values such as the detection frequency of the abnormal shadow candidates on the identical locations. The nodule shadow candidate detecting section 23b is configured to output detection result information Wb that indicates the detection result of whether an abnormal shadow candidate region has been detected or not, and if a nodule shadow candidate Qb has been detected, it also outputs location information Lb that indicates the location of the candidate on the chest X-ray image P together with the detection result information Wb.

The additional imaging information setting section 23e determines whether a nodule shadow candidate Qb has been detected based on the detection result information Wb received from the nodule shadow candidate detecting section 23b (step S5), and if it determines that the nodule shadow candidate has been detected, it sets the location information Lb and information indicating that “tomographic imaging of the chest region is required” as the additional imaging information T (step S6).

In the mean time, when the imaged region is “a breast”, the tumor shadow candidate detecting section 23c performs a process for detecting a tumor shadow candidate Qc on the breast X-ray image P represented by the image data P inputted therein (step S7). A tumor shadow may be detected, for example, by a method that uses an Iris filter to extract a region where density gradients are concentrated on a breast image as described, for example, in Japanese Unexamined Patent Publication No. 2002-074325. The tumor shadow candidate detecting section 23c is configured to output detection result information Wc that indicates the detection result of whether a tumor shadow candidate region has been detected or not, and if a tumor shadow candidate Qc has been detected, it also outputs location information Lc that indicates the location of the candidate on the breast X-ray image P together with the detection result information Wc.

The additional imaging information setting section 23e determines whether the tumor shadow candidate Qc has been detected based on the detection result information Wc received from the tumor shadow candidate detecting section 23c (step S8), and if it determines that the tumor shadow candidate has been detected, it sets the location information Lc and information indicating that “magnified imaging of the tumor shadow candidate region is required” as the additional imaging information T (step S9).

Thereafter, based on the image data P received from the imaged region identifying section 23a, the mammary gland classifying section 23d performs a classifying process for classifying the breast of the breast X-ray image P represented by the image data P into one of a plurality of categories classified according to the distribution of mammary glands. The classifying process may be, for example, a process that classifies a breast on an breast image into four categories of “dense”, “unevenly dense”, “dispersed”, and “fatty” as proposed in the Mammography Guidelines using a method in which a region having densities that fall in a predetermined density range is extracted from a breast image as the mammary gland region, and the breast is classified according to the distribution of mammary glands within the breast (densities and locations of the mammary glands) as described, for example, in Japanese Patent Application No. 2003-297670.

The additional imaging information setting section 23e determines whether the breast has been classified into the category of “dense” or “unevenly dense” which indicates that the breast has relatively dense mammary glands based on the classification result information Wd received from the mammary gland classifying section 23d (step S11), and if it determines that the breast has been classified into one of the categories described above, it sets information indicating that “a medical examination of the breast through ultrasound imaging is required” as the additional information to be included in the additional imaging information T which has been set based on the detection result of the tumor shadow candidate(step S12).

If the imaged region is identified as “other”, nothing is set to the additional imaging information T.

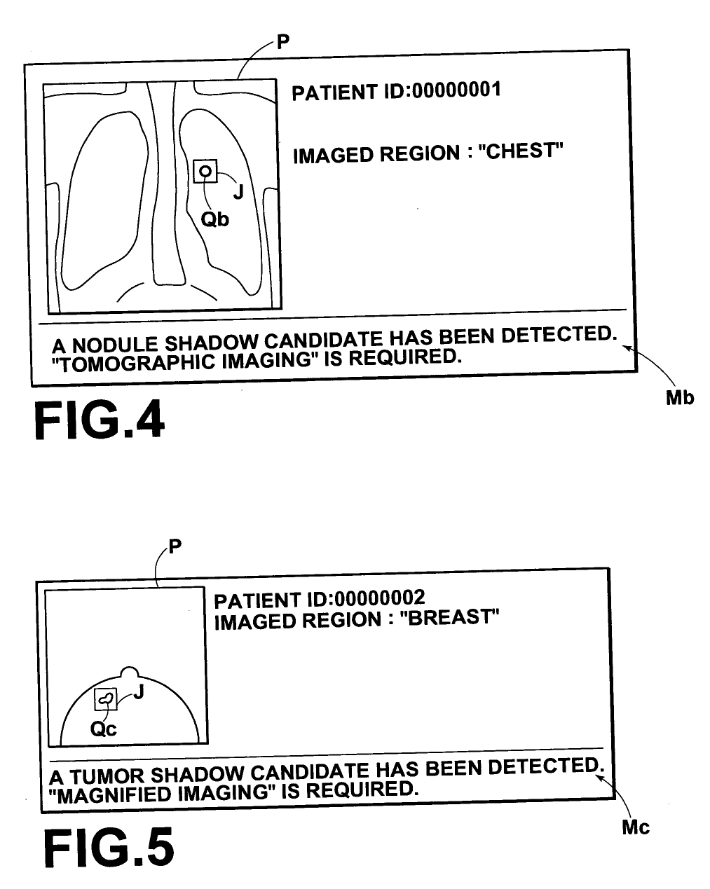

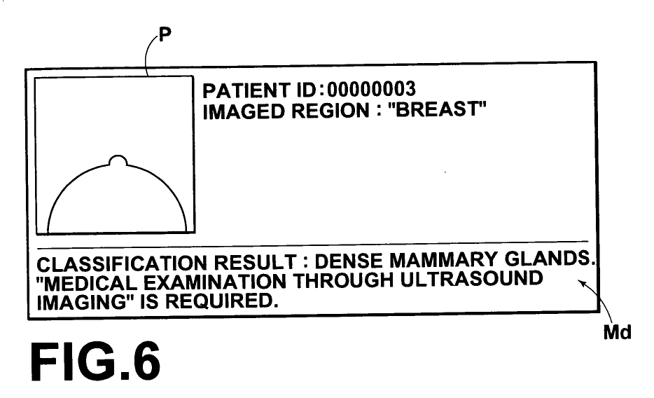

When information is set according to the type of the imaged region and detection or classification result as the additional imaging information T in the manner described above, the additional imaging information output section 24 displays a message that indicates whether additional imaging or an additional medical examination is required and the type thereof, if it is determined necessary, together with the detection result or classification result on the display based on the additional imaging information T received from the additional imaging information setting section 23e (step S13). For example, when a nodule shadow candidate is detected on a chest X-ray image represented by the image data P, the output section 24 displays a mark J that indicates the nodule shadow candidate together with the chest X-ray image P based on the image data P and location information Lb, as shown in FIG. 4. In addition, it displays a message Mb stating “A nodule shadow candidate has been detected. Tomographic imaging of the chest is required”. In the mean time, for example, when a tumor shadow candidate is detected on a breast X-ray image represented by the image data P, the output section 24 displays the mark J that indicates the tumor shadow candidate together with the breast X-ray image P based on the image data P and location information Lc, as shown in FIG. 5. In addition, it displays a message Mc stating “A tumor shadow candidate has been detected. Magnified imaging of the breast is required”. Further, for example, when a breast on a breast X-ray image represented by the image data P is classified into the category of “dense mammary glands” or “unevenly dense mammary glands”, the additional imaging information setting section 23e displays a message Md stating that “classification result: XXXX. A medical examination through ultrasound imaging is required” as shown in FIG. 6. When no additional imaging or medical examination is required, that is, no information is set as the additional imaging information T, the output section 23e may display no information on the display; display only detection result Wb or Wc, or classification result Wd; or display a message stating “Neither additional imaging nor additional medical examination is required” together with the detection or classification result.

The inspection engineer checks to see if there is any problem with regard to the quality of a radiation image obtained through imaging by observing the radiation image and the message stating the requirements of additional imaging and the like displayed on the display screen of the QA-WS 20, and determines whether re-imaging, additional imaging, or an additional medical examination is required. The inspection engineer further performs image quality improvement process on the image data P or obtains new image data through re-imaging if required to obtain an image having an appropriate image quality for interpretation, and outputs the image data that represent the appropriate image to the image storage unit 40. At the same time, the inspection engineer further directs additional imaging or medical examination if deemed necessary. When additional imaging or an additional medical examination is directed by the inspection engineer, the patient so directed is guided to the facility for performing the additional imaging or additional medical examination, where the required additional imaging or medical examination is performed. The additional imaging or medical examination is performed by an imaging or examining equipment (not shown) connected to the network 90, and the newly generated image data or the medical examination report is sent to the image storage unit 40 through the network 90 and stored therein with the patient ID related thereto.

In response to a request from the operator such as a doctor or the like, the image viewer 30 obtains intended image data P (P′) and other related data from the image storage unit 40 based on the patient ID of the patient to be diagnosed, and displays the radiation image, other images, medical examination report and the like on the display screen based on the data obtained from the image storage unit 40. The doctor observes the images and other information displayed on the display screen to perform image interpretation and give a diagnosis.

As has been described, according to the medical image processing system 100 of the present embodiment, the QA-WS 20 (image quality inspection terminal) comprises: the additional imaging determining section 23 (determining section) configured to determine whether additional imaging or an additional medical examination is required based on the image data (medical image) inputted therein, and to further determine the type of the additional imaging or medical examination if it is determined necessary; and the additional imaging information output section 24 (output section) configured to output information which indicates that the additional imaging or medical examination is required and the type thereof if the additional imaging or medical examination is determined necessary by the additional imaging determining section 23. This allows the inspection engineer to direct the imaging or medical examination additionally required in advance by referring to the information outputted from the additional imaging information output section 24. Consequently, the determination whether or not additional imaging or an additional medical examination is required, and the type thereof, if it is determined necessary, maybe made objectively and rapidly prior to the image interpretation to be performed by a doctor. Thus, the efficiency of image interpretation and diagnosis may be further improved.

The determination whether additional imaging or an additional medical examination is required is made through the existing QA-WS 20 of the medical image processing system 100, so that the determination may be made by the inspection engineer simultaneously with the image quality inspection for a medical image obtained by imaging without a separate determination terminal and additional personnel to be allocated to the separate terminal. Thus, additional costs and installation space for the separate terminal are not required.

The additional imaging information T outputted from the QA-WS 20 may be tagged to the image data P or the like, or it may be stored in an external storage unit (not shown) and the link data that indicate the storage location of the information T may be tagged to the image data P or the like. By doing so, the additional imaging information T tagged to the image data P or the like, or that stored in the external storage unit may be called upon to the image viewer 30 directly or through the link data for reconfirmation.

It should be appreciated that there is no rule on which process is to be performed first for the detection of a tumor shadow candidate and classification of a breast on a breast image. In addition, when a tumor shadow candidate is detected, and the breast is classified into either category of “dense mammary glands” or “unevenly dense mammary glands” after performing the two processes, information which indicates the requirement of “magnified imaging of the tumor shadow candidate region” and information which indicates the requirement of “medical examination through ultrasound imaging” may be outputted together.

What is claimed is:

1. A medical image processing system, comprising:
an image generation unit for generating a medical image that represents a test subject;
an image quality inspection terminal having an output decision accepting section for accepting a decision whether to output the medical image generated by the image generation unit and inputted thereto; and
an interpretation terminal for displaying the medical image inputted thereto from the image quality inspection terminal,
wherein the image quality inspection terminal further comprises:
a determining section configured to perform a first determination process for determining whether additional imaging or an additional medical examination is required based on the medical image inputted thereto, and a second determination process for determining the type of the required additional imaging or medical examination, if the additional imaging or medical examination is determined necessary by the first determination process; and
an output section configured to output information which indicates that the additional imaging or medical examination is required and the type thereof, if the additional imaging or medical examination is determined necessary by the determining section.

2. The medical image processing system according to claim 1, wherein:
the medical image is a plain radiation image of a chest;
the determining section comprises a nodule shadow detecting section for detecting a nodule shadow candidate on the plain radiation chest image; and
the determining section is configured to determine that additional imaging is required when the nodule shadow candidate is detected by the nodule shadow detecting section, and to further determine that the type of the additional imaging required is tomographic imaging of the chest.

3. The medical image processing system according to claim 1, wherein:
the medical image is a breast radiation image;
the determining section comprises a tumor shadow detecting section for detecting a candidate of tumor shadow on the breast radiation image; and
the determining section is configured to determine that additional imaging is required when the tumor shadow candidate is detected by the tumor shadow detecting section, and to further determine that the type of the additional imaging required is magnified imaging of the breast.

4. The medical image processing system according to claim 1, wherein:
the medical image is a breast radiation image;
the determining section comprises a mammary gland classifying section for classifying the breast on the breast radiation image into one of a plurality of categories classified according to the distribution of the mammary glands; and
the determining section is configured to determine that additional imaging is required when the breast is classified into a particular category of the plurality of categories, indicating that the breast has relatively dense mammary glands, by the mammary gland classifying section, and to further determine that the type of the additional medical examination required is a medical examination through ultrasound imaging.

5. The medical image processing system according to claim 1, wherein the output section is configured to tag information which indicates that the additional imaging or medical examination is required and the type thereof to a medical image inputted to the image quality inspection terminal when the additional imaging or medical examination is determined necessary by the determining section.
